(19) United States
(12) Patent Application Publication
(10) Pub. No.: US 2026/0298325 A1
(43) Pub. Date: Oct. 1, 2026

(54) HARMONIC SPEED REDUCTION TRANSMISSION DEVICE

(71) Applicant: CHONGMO TECHNOLOGY CO., LTD., Kaohsiung City (TW)

(72) Inventor: Hsun-Yao Liang, Kaohsiung City (TW)

(21) Appl. No.: 19/180,076

(22) Filed: Apr. 15, 2025

(30) Foreign Application Priority Data
Mar. 26, 2025 (TW) 114111529

(51) Int. Cl. F16H 49/00; F16H 57/02; F16H 57/031; H02K 5/04

(52) U.S. Cl. CPC F16H 49/001; F16H 57/031; H02K 5/04; F16H 2049/003; F16H 2057/02034

(57) ABSTRACT

A harmonic speed reduction transmission device includes a harmonic reducer driven by a motor. The motor rotor has an induction portion and a transmission portion formed at opposite ends, respectively. The harmonic reducer comprises a rigid wheel, a flexible wheel engaged with the rigid wheel, and a wave generator assembly that drives the flexible wheel to rotate. The transmission portion of the rotor is directly utilized as an elliptical disk within the wave generator assembly, enabling the transmission portion to sequentially drive a flexible bearing and the flexible wheel in the wave generator assembly. This configuration simplifies the structural arrangement and outputs a rotational speed with a predetermined reduction ratio.

### BACKGROUND OF INVENTION

### 1. Field of the Invention

The present invention relates generally to the structural design of harmonic reducers and motors, and more particularly to a harmonic speed reduction transmission device.

### 2. Description of Related Art

The harmonic reducer generates a speed reduction effect through the elastic deformation of metal and is commonly used in the transmission structures of industrial robots and humanoid robots. It boasts advantages such as compact size, lightweight, high load capacity, high motion accuracy, and a large single-stage transmission ratio.

Conventional harmonic reducers are commonly provided with a housing, with a rigid wheel, a flexible wheel, and a wave generator assembly configured inside. Specifically:

The rigid wheel is a hollow ring-shaped component fixed inside the housing, with a plurality of internal teeth arranged in an annular pattern. It provides guiding support when the flexible wheel rotates.

The flexible wheel is also a hollow ring-shaped component, and has a thin wall portion that can be deformed and a thick wall portion that can maintain rigidity. The thin wall portion has a smooth inner wall surface and a plurality of external teeth arranged in an annular pattern, which can be partially engaged with the internal teeth of the rigid wheel. The number of external teeth is typically fewer than that of the internal teeth (usually by two teeth). The thick wall portion is used as a power output end of the harmonic reducer.

The wave generator assembly is a cylindrical unit comprising an elliptical disk and a flexible bearing tightly fitted around the perimeter of the elliptical disk. The elliptical disk can be used as a power input end of the harmonic reducer. The flexible bearing is a thin-walled ball bearing. Its outer wall can be tightly fitted on the inner wall surface of the flexible wheel.

Therefore, when the harmonic reducer is driven by rotational kinetic energy to rotate the elliptical disk, the elliptical disk sequentially forces the flexible bearing and the thin-walled portion of the flexible wheel to deform into a matching elliptical shape. This in turn causes the flexible wheel to rotate in the opposite direction within the rigid wheel. During this process, because the number of the external teeth of the flexible wheel is slightly fewer than that of the internal teeth of the rigid wheel, and the thin wall portion of the flexible wheel has already deformed into an elliptical shape, actually, only the external teeth of the flexible wheel on the opposite ends of the major axis direction of the ellipse can mesh with the internal teeth of the rigid wheel and rotate slowly on the internal teeth with equal radius to the rigid wheel. This means that for every full rotation (360 degrees) of the elliptical disk, the flexible wheel only rotates reversely by a small arc (determined by the reduced number of external teeth on the flexible wheel). As a result, the flexible wheel rotates significantly slower than the elliptical disk, thereby achieving speed reduction. Consequently, the thick-walled portion of the flexible wheel can output rotational kinetic energy with a predetermined reduction ratio.

In addition, the harmonic reducer usually needs to be combined with a motor to constitute a harmonic speed reduction transmission device, wherein the motor supplies rotational kinetic energy to the harmonic reducer, to output speed-reduced rotational kinetic energy. The motor drives a rotor to rotate through excitation by a stator. However, the rotor must rely on at least one connecting component to sequentially transmit power to the thick-walled portion of the flexible wheel. This configuration inevitably leads to more complex assembly processes and makes structural miniaturization more difficult.

As known, existing patents JP-5659446B2 and CN109895122B have typically disclosed the power transmission technique of the above-mentioned harmonic reducer and motor. However, such patents still require structures similar or identical to the above connecting components to transmit the rotational kinetic energy of the motor rotor to the harmonic reducer. Therefore, it remains challenging to overcome the issue of complex assembly processes, while under specific reduction ratio requirements for kinetic energy output, the aforementioned patents still faces difficulties in achieving structural miniaturization.

These technical limitations have significantly impacted the development goals of industrial robots and humanoid robots for miniaturization and precision. Therefore, it is urgent to find solutions for improvement.

### SUMMARY OF THE INVENTION

In view of the technical limitations inherent in prior art, the inventor has focused on integrating the motor's rotor with the elliptical disk of the wave generator assembly. This integration simplifies assembly processes and reduces the internal space requirements of the harmonic drive transmission device, thereby achieving structural miniaturization.

Therefore, one preferred embodiment of the present invention provides a harmonic speed reduction transmission device, which comprises a harmonic reducer and a motor arranged along a concentric path inside a housing. The harmonic reducer comprises a rigid wheel fixed inside the housing, a flexible wheel engaged inside the rigid wheel, and a wave generator assembly that drives the flexible wheel to rotate. The wave generator assembly includes an elliptical disk, and a flexible bearing connected between the elliptical disk and the flexible wheel. The motor comprises a stator fixed inside the housing and a rotor pivoted inside the stator. Specifically, the rotor is formed with an induction portion and a transmission portion opposite the induction portion. The surface of the induction portion is formed with at least one polarity pair generated by a permanent magnet. The induction portion is located inside the stator to receive the electromagnetic induction from the stator. Most characteristically, the elliptical disk is constituted by the transmission portion.

As evidenced by the aforementioned technical features, the present invention specifically integrates the elliptical disk of the wave generator assembly with the motor's rotor. This innovative configuration eliminates the conventional connecting component between the rotor and elliptical disk, thereby achieving the dual advantages of simplified structure and assembly process.

In a further embodiment, because the rigid wheel is formed with a plurality of internal teeth distributed in an annular pattern, the flexible wheel is formed with a thin wall portion that can be deformed and a thick wall portion that can maintain rigidity, the thin wall portion has a smooth inner wall surface and a plurality of external teeth distributed around the periphery of the thin wall portion in an annular pattern, the flexible wheel can be connected with the flexible bearing via the inner wall surface and be engaged with part of the internal teeth of the rigid wheel via the external teeth.

For this purpose, the present invention specially designs the housing comprising a housing base and a housing cover, which are pivotally connected to each other. The housing base is provided for fixation of the rigid wheel. The housing cover is provided for fixation of the thick wall portion of the flexible wheel, such that the housing cover becomes a power output end of the harmonic speed reduction transmission device.

In more detail, the housing base is formed with a first housing chamber, and the housing cover is formed with a second housing chamber communicating with the first housing chamber. The stator and the induction portion of the rotor are located inside the first housing chamber. The transmission portion of the rotor extends into the second housing chamber. The harmonic reducer is located between the first housing chamber and the second housing chamber. Furthermore, the rotor is formed with a central pivot hole, the housing is formed with a central hub section that can penetrate into the central pivot hole. The rotor is pivoted between the central hub section and the stator via the central pivot hole. In addition, the central hub section is formed inside the housing base, and the central hub section is formed with a mounting hole. The housing cover is formed with an integrally extending central pillar configured for pivotal engagement with the mounting hole.

Compared with the prior art, the present invention makes significant technical contributions in reducing internal space of the device and achieving structural miniaturization.

Furthermore, at least one of the housing base and the rigid wheel is formed with an annular guiding groove. The housing cover is formed with a protruding ring that can be guided by the guiding groove. For the housing cover used as the power output end, this configuration can help enhance the stability during its rotation in relation to the housing base.

In addition, as long as the housing base and housing cover can be pivoted together and there are housing chambers inside, other structural features can be exchanged or slightly changed. All such variations shall be covered by the spirit and scope of the present invention. The implementation and technical effects disclosed above will be described in greater detail with reference to the accompanying drawings and with respect to preferred embodiments.

### BRIEF DESCRIPTION OF THE DRAWINGS

FIG. 1 is an exploded perspective view of the harmonic speed reduction transmission device according to the invention.

FIG. 2 is a sectional view of FIG. 1.

FIG. 3 is a sectional illustration of the housing in FIG. 2, to indicate that the housing is formed by a housing base and a housing cover.

FIG. 4 is an assembly illustration of the motor rotor and flexible wheel in FIG. 2, to indicate that the transmission portion of the rotor is combined with the flexible wheel through the flexible bearing.

### DETAILED DESCRIPTION OF THE INVENTION

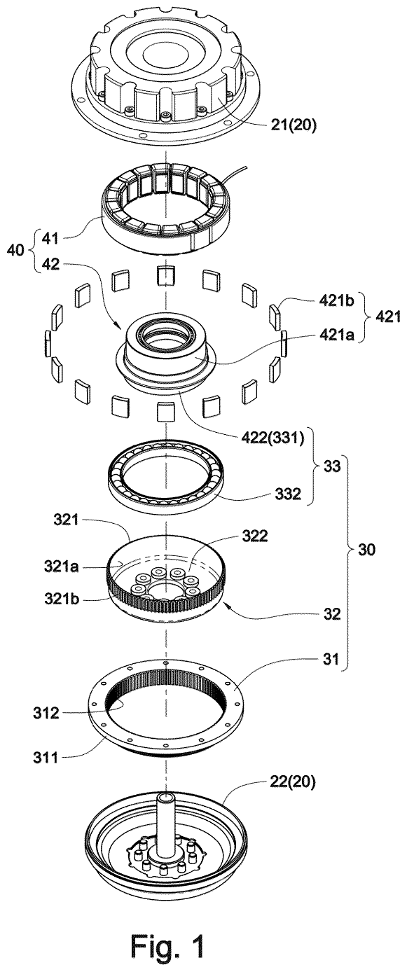

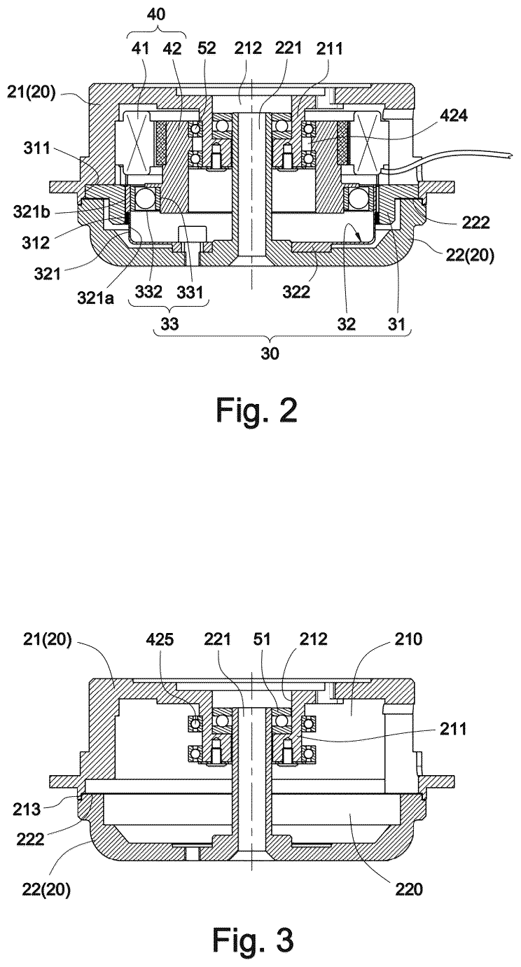

First, please refer collectively to FIG. 1 through FIG. 4. As disclosed, the present invention of a harmonic speed reduction transmission device mainly comprises: a housing 20, with a harmonic reducer 30 and a motor 40, arranged along a concentric path inside the housing 20. Specifically, as depicted in FIG. 1 and FIG. 2, the harmonic reducer 30 comprises a rigid wheel 31 fixed inside the housing 20 along a concentric path, a flexible wheel 32 engaged inside the rigid wheel 31, and a wave generator assembly 33 that drives the flexible wheel 32 to rotate. The wave generator assembly 33 includes an elliptical disk 331, and a flexible bearing 332 connected between the elliptical disk 331 and the flexible wheel 32. The motor 40 can be either a brushless DC motor or a permanent magnetic AC synchronous motor, a stator 41 fixed inside the housing 20, and a rotor 42 pivoted inside the stator 41.

As depicted in FIG. 1 and FIG. 3, the housing 20 in FIG. 2 can be in a ring-shaped body, formed by pivotally connecting a ring-shaped housing base 21 and a ring-shaped housing cover 22. The housing base 21 and the housing cover 22 are respectively formed with a plurality of stepped-ring-shaped internal surfaces, thus constituting a first housing chamber 210 inside the housing base 21 and a second housing chamber 220 inside the housing cover 22 communicating the first housing chamber 210, used to house the harmonic reducer 30 and motor 40 depicted in FIG. 2.

In addition, the housing base 21 can be deemed as the fixing end of the transmission device, for installation on the required end of a device. The center of the housing base 21 can be formed with a central hub section 211 protruding toward the first housing chamber 210. The central hub section 211 is configured with a mounting hole 212. The center of the housing cover 22 is formed with a central pillar 221 that can penetrate into the mounting hole 212, for mounting a first bearing 51 between the mounting hole 212 and the central pillar 221, such that the housing cover 22 can be pivotally mounted to the mounting hole 212 via the central pillar 221 and the first bearing 51. Moreover, the end of the housing base 21 adjacent to the housing cover 22 can be formed with an annular guiding groove 213, and the housing cover 22 is formed with a protruding ring 222 that can be guided by the guiding groove 213, such that the housing cover 22 can rotate freely and stably in relation to the housing base 21, and can be used as a power output end of the transmission device.

In the above structure, the central hub section 211, mounting hole 212, and guiding groove 213 can also be formed inside the housing cover 22. Accordingly, the central pillar 221 and protruding ring 222 of the housing cover 22 are formed inside the housing base 21. In other words, as long as the housing base 21 and the housing cover 22 can be pivoted together and there are interconnected housing chambers, any variation in the implementation of the invention shall be covered by the technical scope of the invention.

FIG. 1 and FIG. 2 depict the configuration form of the rigid wheel 31 and the flexible wheel 32. The rigid wheel 31 is formed with an annular flange 311. The rigid wheel 31 can be tightly fitted on the internal surfaces of the housing base 21 adjacent to the housing cover 22 through the outer surface of the protruding ring 311, such that the rigid wheel 31 is keeping still firmly during the process of transmission with speed reduction. In addition, the rigid wheel 31 is also formed with a plurality of internal teeth 312 distributed in an annular pattern, to guide the flexible wheel 32. Furthermore, the guiding groove 213 can also be formed on the rigid wheel 31 to guide the protruding ring 222 of the housing cover 22.

In addition, the flexible wheel 32 is formed with a thin wall portion 321 that can be deformed and a thick wall portion 322 that can maintain rigidity. The thin wall portion 321 has a smooth inner wall surface 321a and a plurality of external teeth 321b distributed on the periphery of the thin wall portion 321 in an annular pattern. The flexible wheel 32 is connected with the flexible bearing 332 via the inner wall surface 321a and meshes with part of the internal teeth 312 of the rigid wheel 31 via the external teeth 321b, such that the rigid wheel 31 can guide the rotation of the flexible wheel 32. In addition, the flexible wheel 32 can be fixed on the housing cover 22 by penetrating a screw through the thick wall portion 322, such that the flexible wheel 32 can simultaneously drive the housing cover 22 to rotate, thus using the housing cover as a power output end of the transmission device.

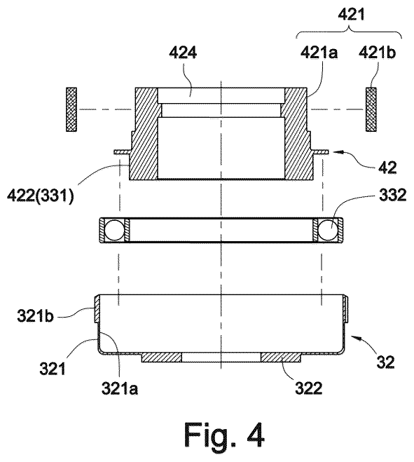

FIG. 4 depicts the configuration details between the rotor 42 and the flexible wheel 32 of the motor 40 shown in FIG. 2. Along the axial direction, the rotor 42 is formed with an induction portion 421 and a transmission portion 422 opposite the induction portion 421, and the induction portion 421 is located inside the stator 41 to receive the electromagnetic induction of the stator 41. The elliptical disk 331 of the wave generator assembly 33 is constituted by the transmission portion 422. More specifically, the induction portion 421 is constituted by a cylindrical magnet seat 421a combined with a plurality of permanent magnets 423b. The plurality of the permanent magnets 423b can respectively form at least one polarity pair with N pole and S pole. As disclosed in FIG. 4, there are a plurality of polarity pairs on the surface of the induction portion 421. However, in practice, only one polarity pair is required to receive the electromagnetic induction generated after electric connection and actuation of the coils inside the stator 41, so as to drive the rotor 42 to generate rotational kinetic energy. Moreover, the transmission portion 422 has an elliptical section, so that it can be used as the elliptical disk 331 of the wave generator assembly 33. Moreover, as disclosed in FIG. 4, the rotor 42 is formed with a central pivot hole 424. Again, as depicted in FIG. 2, through configuration of at least one second bearing 52 inside the central pivot hole 424, the rotor 42 can be pivotally configured between the central hub section 211 and the stator 41. Moreover, FIG. 4 further discloses the structural features of the thin wall portion 321, thick wall portion 322, inner wall surface 321a and external teeth 321b of the flexible wheel 32 shown in FIG. 2, as well as the configuration feature that the flexible bearing 332 can be configured between the inner wall surface 321a of the flexible wheel 32 and the transmission portion 422 (i.e., the elliptical disk 331) of the rotor 42.

Based on the above, when the stator 41 of the motor 40 actuates the rotor 42 to rotate, the transmission portion 422 (i.e., the elliptical disk 331) on the rotor 42 will rotate simultaneously, and will sequentially force the flexible bearing 332 and the thin wall portion 321 of the flexible wheel 32 to deform into a matching elliptical shape. This in turn will cause the flexible wheel 32 to rotate in the opposite direction within the rigid wheel 31. During this process, because the number of external teeth 321b of the flexible wheel 32 is fewer than that of the internal teeth 312 of the rigid wheel 31 (usually by two teeth), and the thin wall portion 321 of the flexible wheel 32 has already deformed into an elliptical shape, actually, only the external teeth 321b of the flexible wheel 32 on the opposite ends of the major axis direction of the ellipse can mesh with part of the internal teeth 312 of the rigid wheel 31, and rotate slowly on the internal teeth 312 with equal radius to the rigid wheel 31. More specifically, for every full rotation (360 degrees) of the rotor 42 of the elliptical disk 331, the flexible wheel 32 only rotates reversely by a small arc of the circle (360 degrees) (determined by the reduced number of external teeth on the flexible wheel). That is to say, the housing cover 22 integrally fixed with the flexible wheel 32 can output a rotational speed with predetermined reduction ratio, slower than the rotational speed generated by the rotor 42, thereby achieving harmonic speed reduction.

Further referring to FIG. 2, based on the above structural design, the stator 41 and the induction portion 421 of the rotor 42 are located inside the first housing chamber 210, the transmission portion 422 (also called elliptical disk 331) of the rotor 42 can extend into the second housing chamber 220, and the harmonic reducer 30 can be located between the first housing chamber 210 and the second housing chamber 220. Because the transmission portion 422 of the rotor 42 can be used as the elliptical disk 331 of the wave generator assembly 33, there is no need to add a connecting component between the rotor 42 and the elliptical disk 331. Therefore, the present invention has demonstrably achieved the effects of reducing structural components and simplifying assembly processes. With regard to minimizing the internal space of the transmission device and ultimately realizing structural miniaturization, this invention indeed makes significant technical contributions.

1. A harmonic speed reduction transmission device, comprising the following components arranged along a concentric path inside a housing:
a harmonic reducer, comprising a rigid wheel fixed inside the housing, a flexible wheel engaged inside the rigid wheel, and a wave generator assembly to drive the flexible wheel, wherein the wave generator assembly includes an elliptical disk, and a flexible bearing fixed between the elliptical disk and the flexible wheel; and
a motor, comprising a stator fixed within the housing, and a rotor pivoted inside the stator;
wherein:
the rotor is formed with an induction potion, the induction portion is located inside the stator and subject to the electromagnetic induction of the stator;
the rotor is also formed with a central pivot hole, the housing is formed with a central hub section that can penetrate into the central pivot hole, the rotor is pivoted between the central hub section and the stator via the central pivot hole;
the housing is formed by a housing base and a housing cover which are pivotally connected to each other, the central hub section is formed inside the housing base, and the central hub section is formed with a mounting hole, the housing cover is internally extended to form a central pillar that can be pivoted inside the mounting hole.

2. The harmonic speed reduction transmission device defined in claim 1, wherein the rigid wheel is formed with a plurality of internal teeth distributed in a ring, the flexible wheel is formed with a thin wall portion that can be deformed and a thick wall portion that can maintain rigidity, the thin wall portion has a smooth inner wall surface and a plurality of external teeth, distributed in a ring along the periphery of the thin wall portion, the flexible wheel is connected with the flexible bearing via the inner wall surface, and through the external teeth, it is engaged with part of the internal teeth of the rigid wheel.

3. The harmonic speed reduction transmission device defined in claim 2, wherein the housing base is provided for fixation of the rigid wheel, the housing cover is provided for fixation of the thick wall portion of the flexible wheel, such that the housing cover becomes a power output end of the harmonic speed reduction transmission device.

4. The harmonic speed reduction transmission device defined in claim 2, wherein the housing base is internally formed with a first housing chamber, the housing cover is internally formed with a second housing chamber communicated with the first housing chamber, the induction portion of the stator and the rotor are located inside the first housing chamber, second and the harmonic reducer is located between the first housing chamber and the second housing chamber.

5. The harmonic speed reduction transmission device defined in claim 1, wherein the surface of the induction portion of the rotor is formed with at least one polarity pair by means of permanent magnets.

6. The harmonic speed reduction transmission device defined in claim 1, wherein, at least one of the housing base and the rigid wheel is formed with an annular guiding groove, and the housing cover is formed with a protruding ring that can be guided by the guiding groove.
